(19) United States
(12) Patent Application Publication
(10) Pub. No.: US 2019/0262949 A1
(43) Pub. Date: Aug. 29, 2019

(54) Apparatus and Method For Laser Processing A Material

(71) Applicant: SPI Lasers UK Limited, Hedge End (GB)

(72) Inventors: Andrew Malinowski, Southampton (GB); Andrè Christophe Codemard, Eastleigh (GB); Mikhail Nickolaos Zervas, Southampton (GB); Paul Martin Harrison, Salisbury (GB); Mark Greenwood, Yelvertoft (GB)

(21) Appl. No.: 16/320,344

(22) PCT Filed: Aug. 3, 2017
(86) PCT No.: PCT/GB2017/000118

§ 371 Date: Jan. 24, 2019

(30) Foreign Application Priority Data
Aug. 4, 2016 (GB) 1613494.2

(51) Int. Cl. B23K 26/38; B23K 26/073; B23K 26/06; B23K 26/08; B23K 26/142; G02B 6/02; G02B 27/48

(52) U.S. Cl. CPC B23K 26/38; B23K 26/073; B23K 26/0665; B23K 26/0648; G02B 27/48; B23K 26/142; G02B 6/02071; G02B 6/02042; B23K 26/0876

(57) ABSTRACT

Apparatus (10) for laser processing a material (11), which apparatus comprises a laser (1) and a beam delivery cable (2), wherein: the laser (1) is connected to the beam delivery cable (2); the beam delivery cable (2) is configured to transmit laser radiation (13) emitted from the laser (1), and the laser radiation (13) is defined by a beam parameter product (4); and the apparatus (10) is characterized in that: the apparatus (10) includes at least one squeezing mechanism (5) comprising a periodic surface (6) defined by a pitch (7); a length (8) of optical fibre (9) that forms part of the laser (1) and/or the beam delivery cable (2) is located adjacent to the periodic surface (6); and the squeezing mechanism (5) is configured to squeeze the periodic surface (6) and the length (8) of the optical fibre (9) together with a squeezing force (12); whereby the beam parameter product (4) is able to be varied by adjusting the squeezing force (12).

### FIELD OF INVENTION

This invention relates to an apparatus and method for laser processing a material.

### BACKGROUND TO THE INVENTION

Laser cutting of steel is achieved by directing the laser beam to the work-piece via a process head which has optics for collimating and focusing the laser beam and a conical copper nozzle to provide a high pressure gas jet which is co-axial with the beam. The basic cutting operation involves the laser beam heating and melting the metal sheet work-piece and the gas jet, known as the assist gas jet, blowing the molten material out of the bottom of the cut-zone. The cutting head is moved over the sheet metal whilst maintaining a constant distance between the nozzle tip and the work-piece surface. The cutting head is moved in a programmed path to create the desired sheet metal profile.

In the case of cutting stainless steel, it is typical to use an inert assist gas. This avoids the creation of metal oxides on the cut-edge faces of the work-piece which can cause problems when the metal part is in use. Since the only heat source for this cutting process is provided by the focused laser beam, a smaller focal spot size with a higher energy power density will provide more efficient cutting by generating a narrower molten region. It is beneficial to use low divergence so that the melt region is narrow through the thickness of the metal. The limit on the smallest practical focal spot is determined by the optical depth of field in conjunction with the material thickness. This is because the cut-width (kerf) must be wide enough to allow the assist gas to travel to the bottom of the cut with sufficient pressure to cleanly remove molten material and avoid dross on the lower cut edge in order to generate a clean cut. For this type of cutting the assist gas must be applied with high pressure, typically in the range of 10 to 20 bar. The diameter of the nozzle outlet is normally in the range 0.5 mm to 2.0 mm, and in general thicker materials require larger nozzles.

In the case of cutting mild steel (also known as low-carbon steel) thicker than 5 mm, it is typical to use oxygen as the assist gas which exothermically reacts with the iron within the work-piece to provide additional heat which increases the cutting speed. This is applied at pressures typically in the range 0.25 bar to 1 bar, which is much lower compared to that used for nitrogen assist gas cutting. For thick section cutting, typically in the range 10 mm to 30 mm thickness, the kerf must be wide enough so that the oxygen assist gas can reach the bottom of the cutting zone with sufficient gas flow to eject the molten material whilst maintaining a dross-free cut. It is typical for thick mild steel cutting for the beam to be defocused such that the beam waist is above the sheet metal surface so that the incident beam diameter on the sheet metal surface is larger than the beam waist. Better quality cuts with lower edge roughness can be obtained when the divergence of the beam is increased.

Most general purpose flatbed laser cutting machines are required to cut a range of metals of varying thickness which must all be with good quality. The choice of focal spot size is typically a compromise of the requirements needed to meet the wide set of process conditions. For cutting thin stainless steel a small focal spot is needed with low divergence whilst for cutting thick mild steel a larger focal spot is needed with higher divergence. Such flatbed cutting machines are designed to work with a laser having a fixed beam quality. In order to increase the processing capabilities, the cutting head may have an augmented optical system firstly to enable limited movement of the focusing lens along the beam path to allow defocusing of the laser beam relative to the work-piece which can increase the incident spot size, and secondly to allow the focal spot diameter to be adjusted. This has limited benefit since a laser having constant laser beam quality will have a fixed relationship between focal spot size and divergence which works in the opposite way to that desired by the cutting process regimes.

Different cutting regimes require either a small spot with low divergence or a large spot with high divergence whereas the fixed beam quality laser can provide a small spot with high divergence and a large spot with narrow divergence. It is therefore not possible to optimize process parameters for all metal types and thicknesses.

Similar limitations arise with other material processing equipment, such as welding, marking, and additive manufacturing. In all these application areas, there is a need for a laser processing apparatus in which the beam parameter product of the laser is able to be varied, and the diameter of the focused laser beam on the material being processed is able to be varied.

An aim of the present invention is to provide an apparatus and method for laser processing a material which reduces the above aforementioned problem.

### THE INVENTION

According to a non-limiting embodiment of the invention, there is provided apparatus for laser processing a material, which apparatus comprises a laser and a beam delivery cable, wherein:
the laser is connected to the beam delivery cable;
the beam delivery cable is configured to transmit laser radiation emitted from the laser; and
the laser radiation is defined by a beam parameter product;

and the apparatus is characterized in that:
the apparatus includes at least one squeezing mechanism comprising a periodic surface defined by a pitch;
a length of optical fibre that forms part of the laser and/or the beam delivery cable is located adjacent to the periodic surface; and
the squeezing mechanism is configured to squeeze the periodic surface and the length of the optical fibre together with a squeezing force;
   whereby the beam parameter product is able to be varied by adjusting the squeezing force.

By selecting the optical fibre and by varying the squeezing force, it is possible to adjust the beam parameter product of typical industrial lasers in a range 0.3 mm·mrad to 30 mm·mrad. Advantageously, both the beam radius and the effective numerical aperture of the laser radiation propagating along the optical fibre may be controlled by varying the squeezing force. It is also possible to adjust or switch the output beam profile of the laser radiation for example from a bell-shaped Gaussian beam profile to a top hat beam profile or to a ring profile; this is very desirable for many laser cutting applications. The invention allows much greater freedom in optimizing material processes such as cutting. Focal spot size and divergence can be optimized for each sheet metal type and thickness. The apparatus can be set up to produce laser radiation with a high beam quality (low beam parameter product) for piercing metals and for cutting stainless steel, and a low beam quality (higher beam parameter product) for cutting thicker mild steel. In the former case, the diameter of the laser radiation when focused on the material should be smaller and with lower divergence than in the latter.

The periodic surface may be chirped. Varying the pitch along the length of the squeezing mechanism, either monotonically or in a non-monotonic fashion, can reduce the amount of squeezing force that is required to obtain the desired beam parameter product or output beam profile, thereby increasing reliability.

The squeezing mechanism may comprise at least two of the periodic surfaces arranged at an angle to each other. The periodic surfaces may have the same pitch. The angle may be a right angle. The angle may be sixty degrees. The squeezing mechanism may be such that one of the periodic surfaces is able to be squeezed against the optical fibre with a different squeezing force than another of the periodic surfaces. The spatial phases of the periodic surfaces may be configured such that the optical fibre is deformed substantially in a helical manner when the squeezing forces are applied to the periodic surfaces. The squeezing forces may be such that the optical fibre is able to be pulled through the periodic surfaces with a force less than 1N, resulting in increased mechanical reliability.

The apparatus may comprise a plurality of the squeezing mechanisms. Having more than one of the squeezing mechanisms reduces the required squeezing forces on each of the squeezing mechanisms, thereby improving reliability.

At least one of the squeezing mechanisms may have a different pitch than another of the squeezing mechanisms. Different pitches enable coupling between different groups of guided modes in the optical fibre. Combining squeezing mechanisms having different pitches provides greater control of the output beam parameter product and output beam profile.

The squeezing mechanism may be a linear squeezing mechanism. This is advantageous if space is at a premium.

The squeezing mechanism may comprise a cylinder. The optical fibre may be wrapped around the cylinder. The squeezing force may be applied along the axis of the cylinder. This provides a compact arrangement making it more convenient to apply the squeezing force over a longer length of the optical fibre than with the linear squeezing mechanism, and permits more than one turn of optical fibre to be used. This enables smaller squeezing forces to be applied, thereby improving long term reliability. It also helps to reduce optical losses in the optical fibre when squeezed.

The pitch may vary along the radius or perimeter of the cylinder. This enables chirped long period gratings to be fabricated.

The optical fibre may have a core with a diameter of at least 10 μm. The diameter may be at least 15 μm. The diameter may be at least 50 μm.

The optical fibre may comprise glass having an outer diameter less than or equal to 100 μm. The outer diameter may be less than or equal to 80 μm. Prior art glass diameters of optical fibres used in equipment for laser processing a material exceed 125 μm. Reducing the diameter enables the optical fibre to be deformed more easily. It also enables pitches of 0.5 mm or lower to be obtained, thus enabling coupling between modes having much larger differences in their propagation constants. Smaller glass diameters therefore provide useful advantages over prior art

The pitch may be less than or equal to 8 mm. The pitch may be less than or equal to 6 mm. The pitch may be less than or equal to 5 mm. The pitch may be in the range 0.5 mm to 4 mm.

The optical fibre may comprise a core that supports a first optical mode having a propagation constant β₁ and a second optical mode having a propagation constant β₂, and the pitch is selected to couple the first optical mode to the second optical mode when the squeezing force is applied. The pitch may be equal to 2π/(β₁-β₂). The squeezing mechanism may distort the optical fibre along its length, the distortion may be defined by a symmetry, and the symmetry may be selected such that it couples the first optical mode to the second optical mode. The squeezing mechanism may be configured such that the output of the optical fibre is capable of being switched from the first optical mode to the second optical mode by varying the squeezing force.

The optical fibre may comprise a core that supports a first optical mode having a propagation constant β₁ and at least one satellite core that supports a second optical mode having a propagation constant β₂, and the pitch may be selected to couple the first optical mode to the second optical mode. There may be at least two of the satellite cores surrounding the core. There may be at least four of the satellite cores surrounding the core. The satellite core may be a ring core. The pitch may be equal to 2π/(β₁-β₂). The squeezing mechanism may distort the optical fibre along its length. The distortion may be defined by a symmetry, and the symmetry may be selected such that the first optical mode is able to couple to the second optical mode.

The apparatus may include a transition optical fibre comprising a central core and at least one satellite core. The satellite core may be configured to expand the beam diameter of the laser radiation propagating in the first optical mode by a different proportion to an expansion of the beam diameter of the laser radiation propagating in the second optical mode. There may be at least four of the satellite cores. The satellite core may be a ring core.

The apparatus may include a beam delivery optical fibre comprising a central core, which beam delivery optical fibre comprises an output end from which the laser radiation is emitted. The beam delivery optical fibre may include a pedestal. The beam delivery optical fibre may include a ring core surrounding the central core. The apparatus may include a taper wherein the taper is such that a diameter of the central core increases towards the output end. The apparatus may include two of the squeezing mechanisms. The second squeezing mechanism may have a periodic surface defined by a pitch, and the periodic surface of the second squeezing mechanism may be applied to the beam delivery optical fibre. The pitch of the second squeezing mechanism may be greater than the pitch of the first squeezing mechanism.

The beam delivery optical fibre may support a fundamental mode having a propagation constant β₁ and a second order optical mode having a propagation constant β₂ and the pitch of the second squeezing mechanism is longer than 2π/(β₁-β₂), and thereby the second squeezing mechanism does not couple the fundamental mode and the second order mode together.

The pitch of the second squeezing mechanism may be selected to couple higher order modes that can propagate in the beam delivery optical fibre together, thereby creating a more uniform output beam profile.

The apparatus may include a lens system positioned to receive the laser radiation from the beam delivery cable. The lens system may be such that a diameter of a focused spot on the material is able to be varied.

The squeezing mechanism may include an actuator.

The apparatus may include a computer, and wherein at least one of the lens system and the actuator is controlled by the computer. The computer may comprise a memory comprising information concerning material parameters. Preferably, the memory contains information enabling lens system and/or actuator signals to be selected depending on the material parameters, which may include the type of material and its thickness. This is a particularly useful aspect of the invention as it allows the divergence of the laser radiation and the diameter of the focused spot to be controlled by controlling the lens system and the signal to the actuator. It therefore allows relatively expensive industrial lasers to be tuned over a wide range of laser processing parameters automatically depending on the material being processed.

The use of more than one squeezing mechanism simplifies the automatic control of the parameters of the laser radiation. Additionally, the use of different squeezing mechanisms on optical fibres having different guidance properties improves the range of control that can be applied.

The apparatus may include a processing head configured to receive the laser radiation from the optical fibre.

The apparatus may comprise a first and a second optical fibre, the first optical fibre having a first core diameter, and the second optical fibre having a second core diameter which is larger than the first diameter. The second optical fibre may be located between the processing head and the first optical fibre. A first one of the squeezing mechanisms may be applied to the first optical fibre, and a second one of the squeezing mechanisms may be applied to the second optical fibre, whereby in use a spot size of the laser radiation propagating in the first optical fibre may be varied with the first squeezing mechanism, and a profile of the laser radiation may be varied with the second squeezing mechanism. This configuration enables the beam parameter product to be controlled to a large extent independently from the output beam profile. Different beam parameter products can be achieved with the same output beam profile. Thus for example, it is possible to output top hat beam profiles with beam parameter products between 4 and 100 using this apparatus.

The apparatus may include a vibrating element attached to, or forming part of, the beam delivery cable. The vibrating element can be configured to vibrate the beam delivery cable. This can be advantageous to remove laser speckle from the laser radiation. The vibrating element can be a piezo-electric element or an electro-magnetic element.

The invention also provides a method for laser processing a material, which method comprises providing a laser and a beam delivery cable, wherein the beam delivery cable is configured to transmit laser radiation from the laser, and the laser radiation is defined by a beam parameter product; the apparatus includes at least one squeezing mechanism comprising a periodic surface defined by a pitch; a length of optical fibre that forms part of the laser and/or the beam delivery cable is located adjacent to the periodic surface; and the squeezing mechanism is configured to squeeze the periodic surface and the length of the optical fibre together with a squeezing force; and adjusting the squeezing force in order to vary the beam parameter product.

The method may include the step of providing a lens system, and positioning the lens system to receive the laser radiation from the beam delivery cable.

The lens system may be such that a diameter of a focused spot on the material is able to be varied, and the method may comprise varying the diameter of the focused spot on the material.

In the method of the invention, the squeezing mechanism may include an actuator.

The method may include the step of providing a computer, and controlling at least one of the lens system and the actuator by the computer. The computer may contain a memory comprising information concerning material parameters.

### BRIEF DESCRIPTION OF THE DRAWINGS

Embodiments of the invention will now be described solely by way of example and with reference to the accompanying drawings in which:

FIG. 1 shows apparatus for laser processing a material according to the present invention;

FIG. 2 shows a squeezing mechanism having a chirped periodic surface;

FIG. 3 shows a squeezing mechanism comprising two periodic surfaces at right angles to each other, the squeezing mechanism being such that it is able to deform the optical fibre in a helix;

FIG. 4 shows a squeezing mechanism comprising three periodic surfaces at 60 degrees with respect to each other;

FIG. 5 shows spatial phases between the three periodic surfaces of FIG. 4;

FIG. 6 shows a squeezing mechanism having second periodic surfaces;

FIG. 7 shows the squeezing mechanism of FIG. 6 assembled together;

FIG. 8 shows a squeezing mechanism in the form of a cylinder;

FIG. 9 shows a squeezing surface that has a uniform pitch;

FIG. 10 shows a squeezing surface that has a chirped pitch;

FIG. 11 shows the effective refractive indices of the fundamental mode and the second order mode of an optical fibre;

FIG. 12 shows the fundamental mode of an optical fibre;

FIG. 13 shows the second order mode of an optical fibre;

FIG. 14 shows an optical fibre having satellite cores;

FIG. 15 shows the optical modes of the optical fibre of FIG. 14;

FIG. 16 shows an optical fibre having a ring core surrounding a central core;

FIG. 17 shows the second order mode of the ring core;

FIG. 18 shows a pedestal optical fibre;

FIG. 19 shows an optical fibre having a ring core surrounding a central core;

FIG. 20 shows an example of the invention in which the apparatus includes a first, a second, and a third optical fibre, and the diameter of the laser radiation guided by the third optical fibre can be switched from 13 μm to 100 μm by applying a squeezing force to a squeezing mechanism;

FIG. 21 shows an example of the invention in which the apparatus includes a first and a second optical fibre, and the diameter of the laser radiation guided by the second optical fibre can be switched from 13 μm to 100 μm by applying a squeezing force to a squeezing mechanism; and

FIG. 22 shows an example of the invention in which the apparatus includes a first, a second, and a third optical fibre, and the output beam profile of the laser radiation emitted by the third optical fibre can be switched from a central beam having a beam diameter of 50 μm to a ring shaped beam having a beam diameter of 100 μm.

### PREFERRED EMBODIMENT

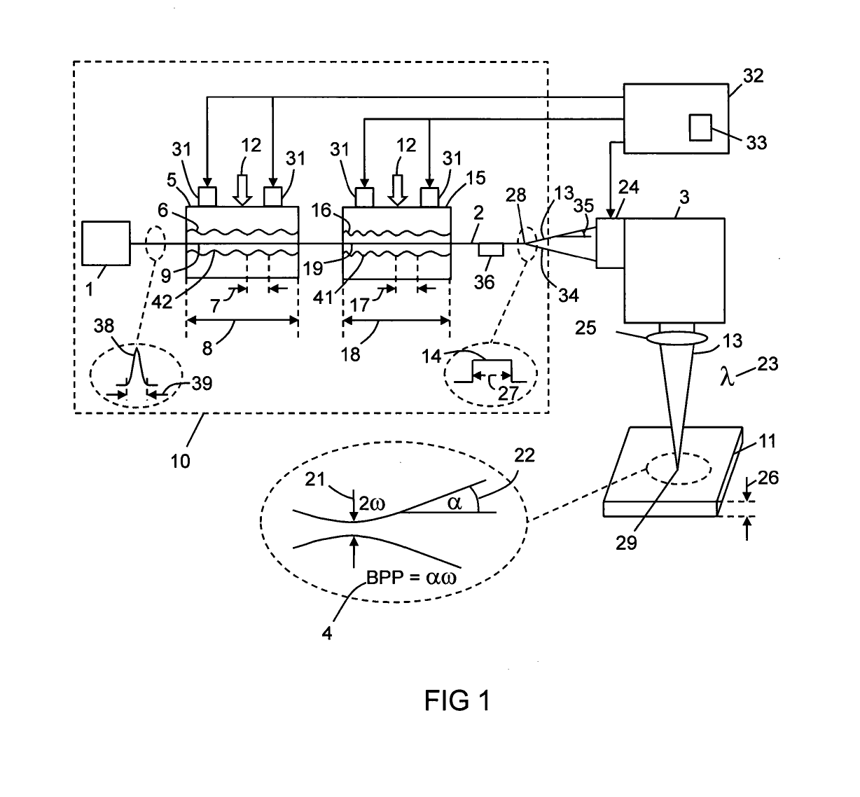

FIG. 1 shows apparatus 10 for laser processing a material 11, which apparatus comprises a laser 1 and a beam delivery cable 2, wherein:
the laser 1 is connected to the beam delivery cable 2;
the beam delivery cable 2 is configured to transmit laser radiation 13 emitted from the laser 1; and
the laser radiation 13 is defined by a beam parameter product 4;

and the apparatus 10 is characterized in that:
the apparatus 10 includes at least one squeezing mechanism 5 comprising a periodic surface 6 defined by a pitch 7;
a length 8 of optical fibre 9 that forms part of the laser 1 and/or the beam delivery cable 2 is located adjacent to the periodic surface 6; and
the squeezing mechanism 5 is configured to squeeze the periodic surface 6 and the length 8 of the optical fibre 9 together with a squeezing force 12;

whereby the beam parameter product 4 is able to be varied by adjusting the squeezing force 12.

The pitch 7 is the distance between successive maxima of the periodic surface 6, and is the reciprocal of the periodicity or spatial frequency of the periodic surface 6. The periodic surface 6 can be a continuous periodic surface made from a single part, such as the periodic surface 6 shown in FIG. 1. Alternatively, the periodic surface 6 can comprise a plurality of parts such as wires or fingers that are assembled together. The wires or fingers may be adjustable such that the pitch 7 is adjustable.

FIG. 1 shows the apparatus 10 optically coupled to a lens system 24, a processing head 3, and a focusing lens 25. The lens system 24 can comprise one or more lenses for collimating and/or magnifying the laser radiation 13. The processing head 3 can include one or more scanning systems for scanning the laser radiation 13 on the material 11. The focusing lens 25 can focus the laser radiation 13 onto the material 11 at a focus point 29.

The beam parameter product 4 is equal to the product of half the beam diameter 2ω 21 of the focused laser radiation 13, and the divergence angle α 22. The beam parameter product 4 is a measure of the beam quality of a laser beam, which can also be characterized by its M² value. The beam parameter product 4 is equal to M²·λ/π, where λ is the wavelength 23 of the laser radiation 13. A single mode fibre laser typically has an M² of approximately 1.1. If the wavelength 23 is 1.06 μm, then the beam parameter product 4 is equal to 0.35 mm·mrad. The beam parameter product 4 of a laser beam is preserved in simple optical systems comprising lenses that have no aberrations. Thus the beam parameter product 4 at the focus 29 is approximately the same as the beam parameter product 34 of the laser radiation 13 as it emerges from the output end 28 of the beam delivery cable 2 from which the laser radiation 13 is emitted. The beam diameter 21 at the focus 29 is substantially equal to the product of the beam diameter 27 at the output end 28 of the beam delivery cable 2 and the magnification of the optical system comprising the lens system 24 and the focusing lens 24. The divergence 22 of the laser radiation 13 is substantially equal to the quotient of the divergence 35 of the laser radiation 13 emitted from the output end 28 of the beam delivery cable 2 and the magnification of the optical system. Thus if the beam diameter 21 is larger than the beam diameter 27, then the divergence 22 is smaller than the divergence 35.

The laser radiation 13 is guided along the optical fibre 9, the optical fibre 19 (if present), and the beam delivery cable 2. The laser radiation 13 has a guided beam profile 38 and a guided beam diameter 39 that can be adjusted or switched by the squeezing mechanism 5. Thus as shown in FIG. 1, the guided beam profile 38 that is depicted as an approximately Gaussian beam profile at the output of the laser 1 has been adjusted to become an output beam profile 14 that is depicted as having a top hat beam profile. The output beam diameter 27 is shown as being larger than the guided beam diameter 39.

By selecting the optical fibre 9 and the squeezing mechanism 5, and by varying the squeezing force 12, it is possible to adjust the beam parameter product 4 of typical industrial lasers in a range 0.3 mm·mrad to 30 mm·mrad. Advantageously, both the beam diameter 27 and the divergence 35 can be controlled by selecting the squeezing force 12. It is also possible to adjust or switch the output beam profile 14 of the laser radiation 13, for example from a bell-shaped Gaussian beam profile such as the guided beam profile 38 shown in FIG. 1, to a top hat beam profile (such as the output beam profile 14 shown in FIG. 1) or to a ring profile. The ability to adjust or switch the output beam profile 14 is very desirable for many laser cutting applications. Being able to change the output beam profile 14 is desirable in many laser material processing applications. For example, a Gaussian profile can be advantageous for piercing the material 11, and a top hat profile or a ring profile can be advantageous for cutting the material 11. Different output beam profiles 14 are advantageous for different applications, and the optimum output beam profile will depend on the material 11 and its thickness 26.

The lens system 24 can comprise collimation optics, a variable beam expander, and/or a telescope. The lens system 24 can be configured to vary the diameter 21 of the focused laser radiation 13 on the material 11. The use of the squeezing mechanism 5 in conjunction with the lens system 24 enables the divergence 22 of the laser radiation 13 and the beam diameter 21 of the laser radiation 13 to be varied independently. This is an extremely attractive feature, allowing the apparatus to provide high beam quality (M²<4) with small diameter 21, medium beam quality (M² between 10 and 20) with a medium beam diameter 21, and low beam quality (M² greater than 30) with a large beam diameter 21. In addition, it is possible to produce a small beam diameter 21 with a medium or low beam quality, and a medium beam diameter 21 with a low or high beam quality. This degree of flexibility allows much greater freedom in optimizing material processes such as cutting. Focal spot size and divergence can be optimized for each sheet metal type and thickness. The apparatus can be set up to produce laser radiation 13 with a high beam quality (low beam parameter product 4) for cutting stainless steel, and a low beam quality (higher beam parameter product 4) for cutting mild steel that has thickness 26. In the former case, the beam diameter 21 of the laser radiation 13 when focused on the material 11 should be smaller and with lower divergence than in the latter case.

The invention is advantageous for cutting metals with lasers. The laser 1 can be a fibre laser, a disk laser, or a solid state laser. The laser 1 can be defined by an output power in the range 500 W to 20 kW.

In an experiment, the laser 1 was a 3 kW ytterbium-doped fibre laser. The wavelength 23 was 1.07 μm. The material 11 was stainless steel. The focused beam diameter 21 was 200 μm and the output beam profile 14 was a top hat profile. When cutting stainless steel having a thickness 26 in the range 2 mm to 8 mm, higher cutting speeds and better cut quality was obtained with a beam parameter product 4 of approximately 3.0 mm·mrad than for a beam parameter product 4 of approximately 4.8 mm·mrad. Conversely, when the material 11 was mild steel having a thickness 26 in the range 15 mm to 30 mm, better results were obtained with a beam parameter product 4 of approximately 4.8 mm·mrad than a beam parameter product 4 of 3.0 mm·mrad. The output profile 14 was a top hat profile. The lower beam quality (higher beam parameter product 4) for mild steel improved the quality of the cut-edge face, reducing surface roughness.

The laser cutting process commences with piercing the material 11 with the laser beam 13. It is advantageous to use a smaller beam diameter 21 with lower divergence 22 at the focus spot 29 when piercing than when cutting. The output profile 14 is preferably a bell shaped profile such as a Gaussian profile. This increases the quality and the speed of the pierce. The beam parameter product 4 when piercing all metals should be less than 3 mm·mrad, preferably less than 1 mm·mrad, and more preferably less than 0.5 mm·mrad.

The advantage of being able to select the beam diameter 27, the divergence 35 and the output beam profile 14 emitted at the output end 28 of the beam delivery cable 2 enables different beam diameters 21 and divergence angles 22 to be selected at the focus point 29, which may be above, within, or below the material 11. For example, with stainless steel, the focus point 29 can be below the material 11 such that the laser radiation 13 is converging at the material 11, whereas for mild steel, the focus point 29 can be above the material 11 such that the laser radiation is diverging at the material 11. Being able to do so by adjusting one or more of the mechanisms 5 is a major advantage over the prior art as it provides a lower cost and simpler system than the alternative which would include adjusting the magnification of the focusing optics.

After piercing, assist gas blows molten metal and debris out of the pierce-hole exit. At this stage the beam diameter 28 and the divergence 35 can be increased to provide the optimum beam diameter 21 and divergence angle 22 at the focus spot 29. The resulting beam parameter product 4 can be selected dependent on the material 11 being processed.

The squeezing mechanism 5 preferably has an opposing periodic surface 42. The periodic surface 6 and the opposing periodic surface 42 are preferably in phase with respect to each other as shown in FIG. 1. Thus as the periodic surface 6 and the opposing periodic surface 42 are squeezed against the optical fibre 9, the optical fibre 9 acts as a spring and is deflected periodically along its length such that the strain energy of the optical fibre 9 is minimized. The deflection of the optical fibre 9 will have the same pitch 7 as the periodic surface 6, but may include additional harmonics at higher spatial frequencies than the periodicity of the periodic surface 6. As the squeezing force 12 is increased, so does the deflection of the optical fibre 9 until the optical fibre 9 is gripped between the periodic surface 6 and the opposing periodic surface 42. Further increases in the squeezing force 12 will induce squeezing stresses across the optical fibre 9.

The periodic surface 6 and the opposing periodic surface 42 may have a non-zero phase with respect to each other. Such a design can induce additional harmonics into the distortion of the optical fibre 9 which may induce coupling between additional sets of optical modes that are supported by the optical fibre 9.

The phase between the periodic surface 6 and the opposing periodic surface 42 can be in antiphase such that the optical fibre 9 is gripped between the periodic surface 6 and the opposing periodic surface 42. Mode coupling is then caused by periodic perturbations induced by the photoelastic effect.

The apparatus in FIG. 1 is shown as having a second squeezing mechanism 15 comprising a periodic surface 16 defined by a pitch 17. The periodic surface 16 can be squeezed against a length 18 of the optical fibre 19. The use of the second squeezing mechanism 15 can reduce the squeezing force 12 required to obtain the required beam diameter 27, divergence 35 and output beam profile 14, thereby reducing the risk of breaking the optical fibre 9 and increasing mechanical reliability. The second squeezing mechanism 15 can also be used to couple higher order optical modes together in which case the pitch 17 is preferably longer than the pitch 7.

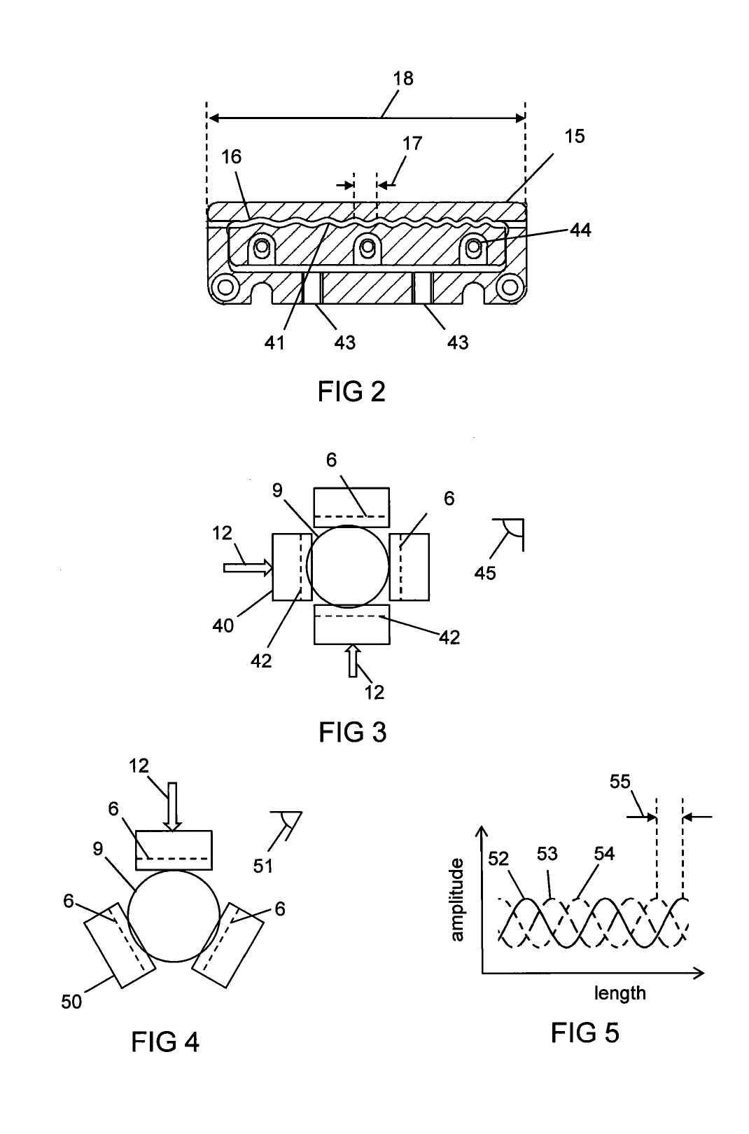

As shown in FIG. 1, the periodic surface 16 may be chirped, that is, its pitch 17 may vary along the length of the squeezing mechanism 15. The pitch 17 can vary in a monotonic fashion (as shown) or a non-monotonic fashion. The chirp reduces the amount of the squeezing force 12 that is required to obtain the desired beam parameter product 4 or output beam profile 14, thereby increasing reliability. FIG. 2 shows an example of a squeezing mechanism 15 that is chirped. The squeezing mechanism 15 has an opposing periodic surface 41, and the optical fibre 19 (not shown) is squeezed between the periodic surface 16 and the opposing periodic surface 41. The squeezing force 12 can be applied via at least one of the holes 43 which may be tapped holes. The opposing periodic surface 41 can be secured in place using fixing screws fitted through at least one of the holes 44.

The periodic surface 16 and the opposing periodic surface 41 are preferably in phase with respect to each other as shown in FIG. 1. Thus as the periodic surface 16 and the opposing periodic surface 41 are squeezed against the optical fibre 19, shown with reference to FIG. 1, the optical fibre 19 acts as a spring and is deflected along its length such that the strain energy of the optical fibre 19 is minimized. The deflection will have the same pitch 17 as the periodic surface 16, but may include additional harmonics which may be desirable to couple additional modes guided by the optical fibre 19 together. As the squeezing force 12 is increased, so does the deflection of the optical fibre 19 until the optical fibre 19 is gripped between the periodic surface 16 and the opposing periodic surface 41. Further increases in the squeezing force 12 will induce further squeezing stresses across the optical fibre 19. Alternatively, the periodic surface 16 and the opposing periodic surface 41 may have a non-zero phase with respect to each other. Such a design can induce additional harmonics into the distortion of the optical fibre 19 which may induce coupling between additional sets of optical modes that are supported by the optical fibre 19. The phase between the periodic surface 16 and the opposing periodic surface 41 can be in antiphase such that the optical fibre 19 is gripped between the periodic surface 16 and the opposing periodic surface 41. Mode coupling is then caused by periodic perturbations induced by the photoelastic effect.

The squeezing mechanism 5 may comprise two of the periodic surfaces 6 arranged at an angle 45 to each other as shown in the squeezing mechanism 40 shown in FIG. 3. Each of the periodic surfaces 6 has an opposing periodic surface 42 of the same or similar design. As described with reference to FIGS. 1 and 2, the periodic surfaces 6 may have the same phase as their respective opposing periodic surface 42. As each of the periodic surface 6 is squeezed against the optical fibre 9, the length of the optical fibre 9 acts as a spring and is distorted along its length. The periodic surfaces 6 of the squeezing mechanism 40 may have the same pitch 7 as each other or a different pitch 7 from each other. The angle 45 may be a right angle. The squeezing mechanism 40 is shown in cross section with the optical fibre 9 shown offset from the central line of the squeezing mechanism 40 by one of the periodic surfaces 6.

The squeezing mechanism 40 may be such that each periodic surface 6 is able to be squeezed against the optical fibre 9 with different squeezing forces 12. The spatial phases of the two periodic surfaces 6 may be 90 degrees out of phase with respect to each other such that the optical fibre 9 can be deformed in a substantially helical manner when the squeezing forces 12 are applied to the two periodic surfaces 6. As described with reference to FIGS. 1 and 2, the optical fibre 9 will act as a spring, and be deformed so as to minimize its strain energy. The deformation of the optical fibre 9 may therefore not be exactly helical, but may contain harmonics. These harmonics can be advantageous in coupling between certain sets of optical modes that are guided by the optical fibre 9. This arrangement provides great control over which guided modes of the optical fibre 9 are coupled to which.

The squeezing mechanism 5 may comprise an odd number of the periodic surfaces 6 arranged at an angle 51 to each other as shown in the squeezing mechanism 50 shown in FIG. 4. The angle 51 is preferably the product of 180 degrees and (n-2)/n where n is the number of the periodic surfaces 6. As shown with reference to FIG. 5, the periodic surfaces 6 preferably have relative spatial phases 55 with respect to each other equal to 360 degrees divided by the number of the periodic surfaces 6. The odd number is preferably three, and the angle 51 is preferably 60 degrees. FIG. 5 shows the amplitudes 52, 53, 54 of each of the three periodic surfaces 6 shown in FIG. 4 along the length of the squeezing mechanism 50. The periodic surfaces 6 have a relative spatial phase 55 of 120 degrees with respect to each other. As each of the periodic surface 6 is squeezed against the optical fibre 9, the length of the optical fibre 9 acts as a spring and is distorted along its length in a substantially helical manner. As described with reference to FIGS. 1, 2, and 3 the optical fibre 9 will act as a spring, and be deformed so as to minimize its strain energy. The deformation of the optical fibre 9 may therefore not be exactly helical along its length, but may contain harmonics of the periodicity of the helix (defined as the reciprocal of the pitch 7). These harmonics can be advantageous in coupling between certain sets of optical modes that are guided by the optical fibre 9.

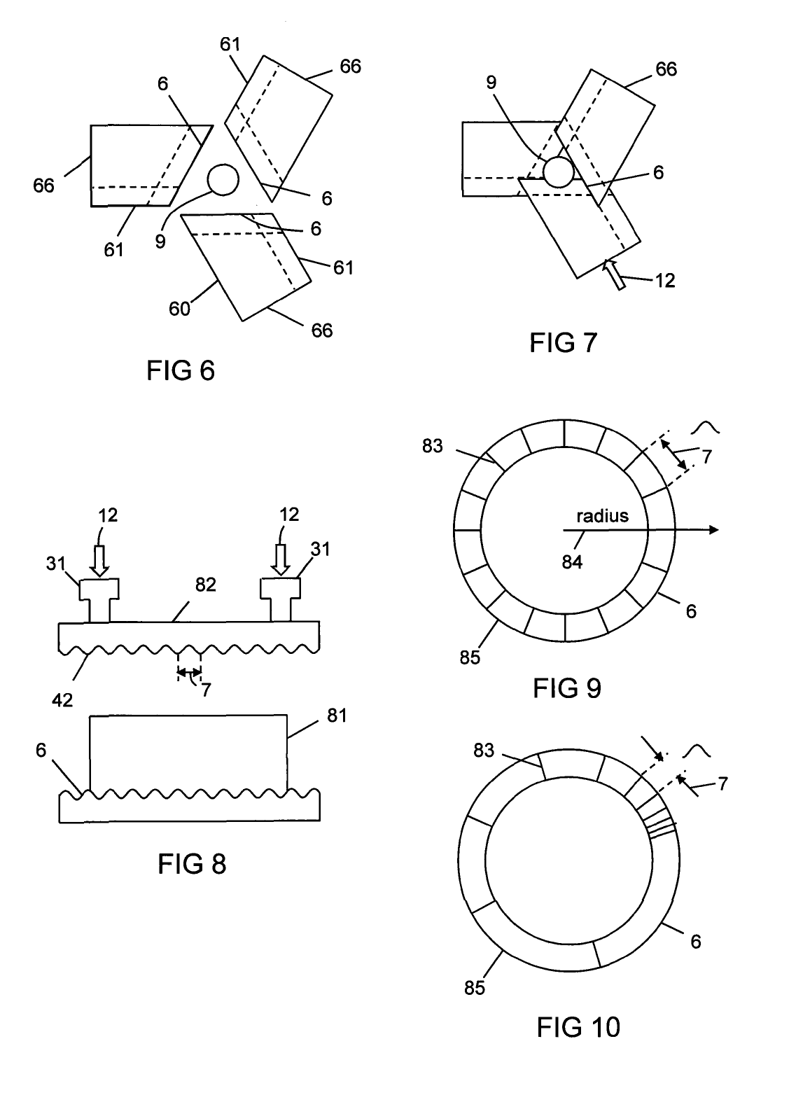

The squeezing mechanism 5 may be the squeezing mechanism 60 shown with reference to FIG. 6 which comprises at least three parts 66 that have a second periodic surface 61 that is designed to align to a periodic surface 6 of another of the parts 66. As described with reference to FIGS. 4 and 5, the three periodic surfaces 6 preferably have a relative spatial phase 55 of 120 degrees with respect to each other. In order for the parts 66 to fit together, the second periodic surface 61 of each of the parts 66 has a relative spatial phase 55 of 120 degrees with respect to the periodic surface 6 of the same part 66. FIG. 7 shows one arrangement in which the three parts 66 have been fitted together and a squeezing force 12 applied. The optical fibre 9 is shown deflected by one of the parts 66. Other arrangements to fit the parts 66 together are also possible, including arrangements in which one of the second periodic surfaces 61 is squeezed against the optical fibre 9. Experimentally, it has been observed that the LP₀₁ mode guided by the optical fibre 9 can be preferentially coupled to LP₃₁ and LP₃₂ modes. This may be as a result of the threefold symmetry of the squeezing mechanism 50. Advantageously, the squeezing force in the squeezing mechanisms 40, 50, 60 described with reference to FIGS. 3 to 7 require substantially less squeezing forces 12 than the squeezing mechanism 15 shown with reference to FIG. 2 for a similar level of mode coupling from the fundamental LP₀₁ mode guided by the optical fibre 9. In an experiment, the squeezing force 12 was sufficiently small that the optical fibre 9 could be pulled from the squeezing mechanism shown in FIG. 7 with a force less than 1N, despite there being significant amounts of mode coupling. The ability to reduce the squeezing force 12 for the same levels of mode coupling improves reliability.

The apparatus may comprise a plurality of the squeezing mechanisms 5. Including a plurality of the squeezing mechanisms can reduce the required squeezing forces 12 on each of the squeezing mechanisms 5 thereby improving reliability.

At least one of the squeezing mechanisms 5 may have a different pitch 7 than another of the squeezing mechanisms 5. Different pitches 7 cause coupling between different groups of guided modes in the optical fibre 9. Combining squeezing mechanisms 5 having different pitches 7 provides greater control of the output beam parameter product 4 and the output beam profile 14.

The squeezing mechanism 5 may be a linear squeezing mechanism 5 such as shown with reference to FIGS. 1 to 4, 6 and 7. This is advantageous if space is at a premium.

The squeezing mechanism 5 may comprise a cylinder 81 as shown in FIG. 8. The optical fibre 9 (not shown) may be wrapped around the cylinder 81. The squeezing force 12 may be applied along the axis of the cylinder 81 for example by squeezing the optical fibre 9 with a ring 82. The ring 82 is shown as having an opposite periodic surface 42, but it does not necessarily have to. The pitch 7 may be uniform or chirped, as shown by the top surfaces of examples of the periodic surface 6 in FIGS. 9 and 10 respectively where each period is shown by a line 83. The periodic surface 6 may be configured in a plane, as shown in FIG. 8, or on a curved surface. The cylinder 81 may be circular or oval. Other shapes are also possible. The pitch 7 may vary along the radius 84 of the perimeter 85 of the cylinder 81. This enables chirped long period gratings to be fabricated.

The squeezing mechanism 5 in the form of the cylinder 81 provides a compact arrangement making it more convenient to apply the squeezing force 12 over a longer length 8 of the optical fibre 9 than with the linear squeezing mechanism 5, and permits more than one turn of optical fibre 9 to be used. This enables smaller squeezing forces 12 to be applied, thereby improving long term reliability. It also helps to reduce optical losses in the optical fibre 9 when squeezed.

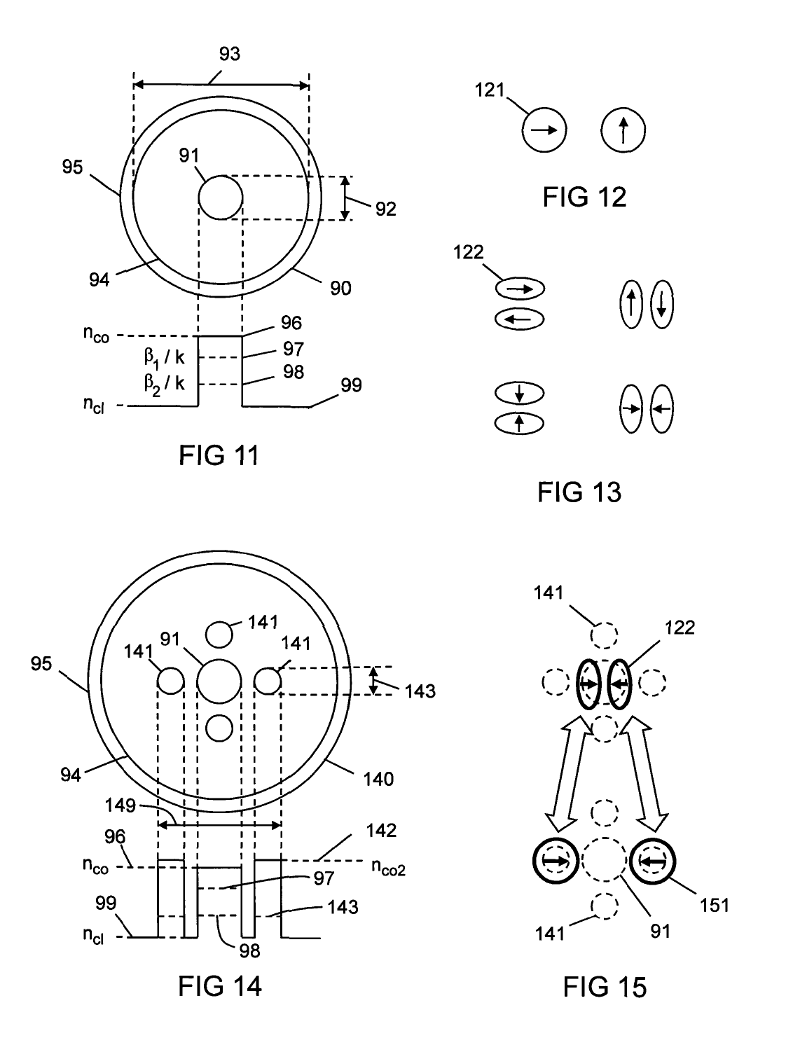

The optical fibre 9 and/or the optical fibre 19 can be the optical fibre 90 shown with reference to FIG. 11. The optical fibre 90 has a core 91, a glass cladding 94, and a polymer coating 95. The core 91 preferably has a diameter 92 of at least 10 μm. The diameter 92 may be at least 15 μm. The diameter 92 may be at least 50 μm. Increasing the core diameter 92 enables the optical fibre 90 to guide an increasing number of optical modes.

The core 91 has a refractive index 96 that is larger than a refractive index 99 of the glass cladding 94. Preferably the optical fibre 9 supports at least a fundamental mode 121 shown with reference to FIG. 12 and a second order mode 122 shown with reference to FIG. 13. The fundamental mode 121 may be the LP₀₁ mode which can occur in two orthogonal polarization states. The second order mode 122 may be the LP₁₁ mode which can occur in two orientations, both of which can occur in two orthogonal polarization states. Thus there are two fundamental modes 121 and four second order modes 122 as shown in FIGS. 12 and 13 respectfully.

The LP₀₁ and LP₁₁ modes are more generally described as LP_{p,q} modes, where p is the azimuthal mode number, and q is the radial mode number. 2p is the number of lobes around the azimuth, and q is the number of lobes along the radius. Thus the LP₀₁ mode has zero lobes around the azimuth, and one lobe along the radius. The LP₁₁ mode has two lobes around the azimuth and one lobe along the radius. The squeezing mechanism 5 will couple a first mode to a second mode if the overlap integrals of the product of the perturbation of the optical fibre 9 induced by the squeezing mechanism 5, the electric field of the first mode, and the electric field of the second mode integrate to a non-zero value over the length 8 of the optical fibre 9. As explained below, this places requirements on the propagation constants of the first mode and the second mode, and the periodicity of the periodic surface 7. It also places symmetry requirements on the electric fields of the first mode and the second mode compared to the perturbation of the optical fibre.

Referring to FIG. 11, the fundamental mode 121 has an effective index 97 of β₁/k and the second order mode 122 has an effective index 98 β₂/k, where β₁ and β₂ are the propagation constants of the fundamental mode 121 and the second order mode 122 respectively, and k is the wavenumber which is related to the wavelength λ 23 of the laser radiation 13 by k=2π/λ. It is useful to consider the difference in the propagation constants Δβ=β₁-β₂. In order for the squeezing mechanism 5 shown with reference to FIGS. 1 to 7 to couple the LP₀₁ mode to the LP₁₁ mode, it is required that there is a spatial frequency component in the distortion of the optical fibre 9 along its length that is equal to Δβ/2π. This will occur if the periodicity (defined as the reciprocal of the pitch 7) is equal to Δβ/2π, or a harmonic of the periodicity is equal to Δβ/2π. However it is also important to consider the symmetry of the perturbation of the optical fibre 9 compared to the optical modes.

If p is non-zero, then the azimuthal dependence of the electric fields for each LP_{p,q} mode guided by a core of the optical fibre 9 can be expressed by the following:

E(r,θ)=E(r)·cos(pθ)

E(r,θ)=E(r)·sin(pθ)

where E(r) is the radial dependence of the electric field, and the cos(pθ) and sin(pθ) represent the two orientations shown in FIG. 13 (for p=1).

When the optical fibre 9 or the optical fibre 19 has a linear sinusoidal deflection along its length (for example induced by a linear squeezing mechanism, such as shown in FIGS. 1 and 2 where the pitch 7 is uniform along the length 8), then by symmetry considerations, only one of these two orientations will be coupled when the pitch 7 equals 2π/Δβ. This assumes that the second order modes 122 in FIG. 13 are degenerate. More generally, the LP₀₁ mode guided by a core can couple to a LP_{p,q} mode guided by the same core if p is an odd integer if the pitch 7 is equal to 2π/(β_{A}-β_{B}), where β_{A} and β_{B} are the propagation constants of the optical modes being coupled together. However the coupling to the LP₁₁ mode will be the strongest unless there are significant harmonics in the sinusoidal deflection. If p is an even integer, then the symmetry of the perturbation is incorrect. By a similar symmetry argument, the linear squeezing mechanism also will not couple the LP₀₁ mode to a LP_{0q} mode if the fibre has a sinusoidal deflection along its length. As will be explained below, the LP₀₁ mode and other optical modes guided by a central core can also couple to optical modes that are guided by satellite cores that are adjacent to the central core. Such coupling can occur if the overlap integral referred to above is non zero.

If the periodic surface 6 and the opposing periodic surface 42 are in antiphase (as opposed to the in-phase arrangement shown in FIG. 1), then the optical fibre 9 will be compressed periodically along its length. Mode coupling will then be induced by the photoelastic effect. By symmetry considerations, the LP₀₁ mode will not couple to the LP₁₁ mode because the symmetry is incorrect. However the LP₀₁ mode is able to couple to the LP₂₁ mode, or more generally to LP_{p,q} modes where p=2, 4, 8 etc if the pitch 7 is equal to 2π/(β_{A}-β_{B}), where β_{A} and β_{B} are propagation constants of the optical modes being coupled together. However this arrangement is not generally preferred because the squeezing force 12 required to obtain appreciable mode coupling is generally much larger than the squeezing force 12 required when the periodic surface 6 and the opposing periodic surface 42 are in phase as shown with respect to FIG. 1.

When the optical fibre 9 or the optical fibre 19 has a helical distortion (for example induced by one of the squeezing mechanisms shown in FIGS. 3, 4, 6 and 7) then by symmetry arguments the LP₀₁ mode can couple to the LP_{p,q} modes in both orientations when the pitch 7 equals 2π/Δβ. However it will not couple if p is an even integer, or to a LP_{0q} mode. There is thus at least twice the amount of mode coupling provided by the squeezing mechanisms shown in FIGS. 3, 4, 6 and 7 than the squeezing mechanisms shown in FIGS. 1 and 2. As discussed with reference to FIG. 5, the squeezing mechanism 60 comprises three of the parts 60 which deform the optical fibre 90 into a helix. It was observed that the LP₀₁ mode coupled to the LP₃₁ and LP₃₂ modes. This implies either that there is a three fold azimuthal perturbation along the optical fibre 90 induced by the squeezing mechanism 60 that provides the required symmetry for the coupling.

As before, if the periodic surface 6 and the opposing periodic surface 42 of the mechanisms 40, 50 and 60 are in antiphase such that the optical fibre 9 is compressed periodically along its length, then the mode coupling is between a different set of the optical modes. From symmetry considerations, the LP₀₁ mode will couple to the LP_{0q} modes. This arrangement is not generally preferred because it requires larger squeezing forces 12 for a comparable effect.

Once coupled from the LP₀₁ mode, the light can couple or scatter more easily into other higher order modes because (i) the difference in propagation constants Δβ between these modes is generally smaller than the difference in propagation constants Δβ between the LP₀₁ mode and the first mode it couples to, and (ii) statistically, there will be perturbations in the optical fibre 9 that occur with longer spatial frequencies than the periodicity.

The helical squeezing mechanisms 30, 40, 50, 60 shown with reference to FIGS. 3, 4, 6 and 7 with the optical fibre 9 perturbed in a helical manner are therefore advantageous in that they couple more orientations of the modes together than the linear squeezing mechanism shown with reference to FIGS. 1 and 2, and further, the squeezing force 12, and hence the maximum deflection of the optical fibre 9, required to provide the coupling is less which results in less stress being applied to the optical fibre 9, and thus higher reliability. Experimentally, it has been observed that the optical fibre 9 can be pulled from helical squeezing mechanisms such as shown in FIG. 7 with a pulling force less than 1N. This is substantially less than the pulling force required to pull the optical fibre 9 from linear squeezing mechanisms such as shown in FIG. 2 where the helical and the linear squeezing mechanisms induce similar levels of mode coupling in the optical fibre 9. Less squeezing forces 12 are therefore being applied to the optical fibre in the helical squeezing mechanism, implying greater mechanical reliability.

As shown in FIG. 14, the optical fibre 9 and the optical fibre 19 can have at least one satellite core 141 adjacent to the core 91. The optical fibre 140 has four of the satellite cores 141 which are spaced symmetrically around the core 91. Each satellite core 141 can have a refractive index 142 and a diameter 143 such that its optical mode 151 shown with reference to FIG. 15 has substantially the same effective index 143 as the effective index β₂/k 98 of the second order mode 122 shown with reference to FIGS. 11 and 13. The optical mode 151 will then resonantly couple to the second order mode 122. The resonant coupling is indicated by the double ended arrows in FIG. 15. The squeezing mechanism 5 shown with reference to FIGS. 1, 2, 3, 4, 6 and 7 can thus be configured to couple the LP₀₁ mode of the core 91 to the LP₁₁ mode of the core 91, which will then couple to the optical mode 151 of the satellite cores 141. Alternatively or additionally, if the squeezing mechanism 5 shown with reference to FIGS. 1, 2, 3, 4, 6 and 7 is applied to the optical fibre 140, then the squeezing force 12 can be selected such as to cause coupling from the LP₀₁ fundamental mode 121 directly to the optical mode 151 of the satellite cores 141, even if the design of the core 91 is such that the core 91 does not support a second-order LP₁₁ mode 122. As per the previous discussion, if the optical fibre 9 is distorted sinusoidally in a linear fashion, then the coupling will be strongest in only one azimuthal orientation. If distorted in a helical fashion, then coupling will occur in all azimuthal orientations. Advantageously, the inclusion of the satellite cores 141 enables the laser radiation 13 to be coupled from the core 91 to the satellite cores 141, thus increasing the guided beam diameter 39 of the laser radiation 13 as it propagates along the optical fibre 9.

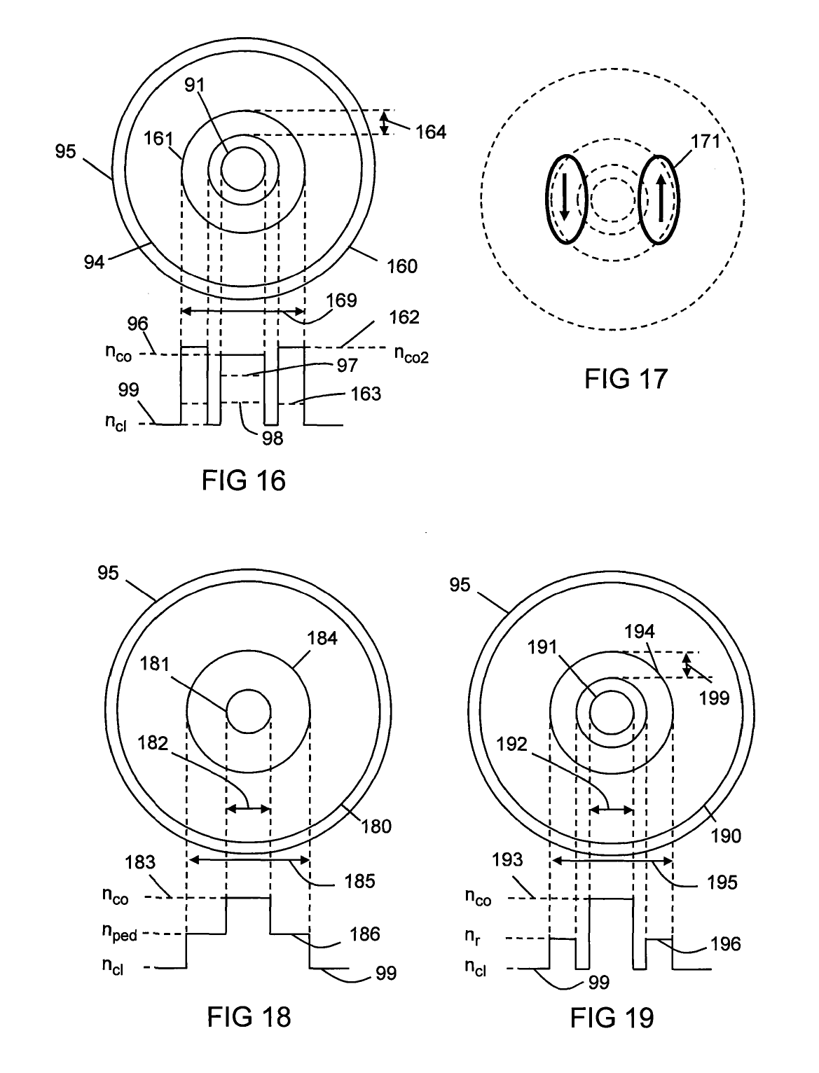

As shown in FIG. 16, the optical fibre 9 and the optical fibre 19 can be an optical fibre 160 that has a ring core 161 surrounding the core 91. The ring core 161 can have a refractive index 162 and a thickness 164 such that its second order mode 171 shown with reference to FIG. 17 has an effective index 163 that is substantially the same as the effective index β₂/k 98 of the second order mode 122 shown with reference to FIGS. 11 and 13. If the second order mode 122 of the core 91 is launched into the optical fibre 160, then the second order mode 122 will resonantly couple to the second order mode 171. Alternatively or additionally, if the squeezing mechanism 5 shown with reference to FIGS. 1, 2, 3, 4, 6 and 7 is applied to the optical fibre 160, then the squeezing force 12 can be selected such as to cause coupling from the LP₀₁ fundamental mode 121 directly to the optical mode 171 of the ring core 161, even if the design of the core 91 is such that the core 91 does not support a second-order LP₁₁ mode 122. As per the previous discussion, if the optical fibre 9 is distorted sinusoidally in a linear fashion, then the coupling will be strongest in only one azimuthal orientation. If distorted in a helical fashion, then coupling will occur in all azimuthal orientations. Advantageously, the inclusion of the ring core 161 enables the laser radiation 13 to be coupled from the core 91 to the ring core 161, either directly or indirectly via the second order LP₁₁ mode 122, thus increasing the guided beam diameter 39 of the laser radiation 13 at it propagates along the optical fibre 9.

Referring to FIGS. 11, 14 and 16, the glass cladding 94 can have a diameter 93 that is between 70 μm and 500 μm. The diameter 93 may be between 70 μm and 200 μm. The diameter 93 is preferably less than or equal to 125 μm. The diameter 93 is more preferably less than or equal to 80 μm. Reducing the diameter 93 enables the optical fibre 9 to be deformed more easily. It also enables pitches 7 of 0.5 mm or lower to be obtained, thus enabling coupling between modes having larger differences in their propagation constants. Smaller glass diameters 93 combined with smaller pitches 7 therefore provide useful advantages over the prior art.

Referring to FIGS. 1 to 4, and 6 to 10, the pitch 7 can be less than 12 mm. The pitch 7 can be less than 5 mm. The pitch 7 can be in the range 0.5 mm to 5 mm.

Referring to FIG. 1, the optical fibre 9, or optical fibre 19 if present, are coupled to the beam delivery cable 2. The beam delivery cable 2 may comprise the optical fibre 180 shown with reference to FIG. 18. The optical fibre 180 has a core 181 having a diameter 182 and a refractive index 183. The optical fibre 180 also comprises a pedestal 184 having a diameter 185 and a refractive index 186. The diameters 182 and 185 and the refractive indices 183 and 186 can be selected to preserve the proportion of the laser radiation 13 that propagates in the core 91 of the optical fibre 9 or the optical fibre 19 if present. Thus for example, if spliced to the optical fibre 140 of FIG. 14, the diameter 182 can be selected to be substantially the same as the diameter 92, and the diameter 185 can be selected to be substantially the same as or greater than the outer edge to outer edge distance 149. The refractive index 186 can be selected to be substantially the same or higher than the refractive index 142. The refractive index 183 can be selected to be substantially equal to the refractive index 142 plus the difference in the refractive indices 96 and 99. Laser radiation 13 that is coupled from the core 91 of the optical fibre 140 into one or more of the satellite cores 141 can thus be coupled into the pedestal 184 of the optical fibre 180 and propagated along the beam delivery cable 2.

The beam delivery cable 2 may comprise the optical fibre 190 shown with reference to FIG. 19. The optical fibre 190 has a core 191 having a diameter 192 and a refractive index 193. The optical fibre 190 also comprises a ring core 194 having a diameter 195, a refractive index 196, and a thickness 199. The diameters 192 and 195, the thickness 199, and the refractive indices 193 and 196 are selected to preserve the proportion of the laser radiation 13 that propagates in the core 91 of the optical fibre 9 or optical fibre 19 if present. Thus for example, if spliced to the optical fibre 160 of FIG. 16, the diameter 192 can be selected to be substantially the same as the diameter 92, the thickness 199 can be selected to be substantially the same as the thickness 164, the and the diameter 195 can be selected to be substantially the same as the diameter 169. The refractive index 196 can be selected to be substantially the same or higher than the refractive index 162. The refractive index 193 can be selected to be substantially equal to the refractive index 96. Laser radiation 13 that is coupled from the core 91 of the optical fibre 160 into the ring 161 can thus be coupled into the ring 194 of the optical fibre 190 and propagated along the beam delivery cable 2.

Referring again to FIG. 1, the squeezing mechanism 5 may include at least one actuator 31. The actuator 31 may comprise an electric motor and/or an electromagnet. The actuator may comprise a ratchet. Application of an electrical signal can be used to provide the squeezing force 12 via the actuator 31.

The apparatus 10 may include a computer 32. At least one of the lens system 24 and the actuator 31 may be controlled by the computer 32. The computer 32 may contain a memory 33 comprising information concerning material parameters. Preferably, the memory 33 contains information enabling signals driving the lens system 24 and/or at least one of the actuators 31 to be selected depending on the parameters of the material 11. The parameters may include the type of material and its thickness 26. This is a particularly useful aspect of the invention as it allows the divergence 22 of the laser radiation 13 and the diameter 21 of the focused laser radiation 13 to be controlled by controlling the lens system 24 and the signal to the actuator 31. It therefore allows relatively expensive industrial lasers 1 to be tuned over a wide range of laser 1 processing parameters automatically depending on the material being processed.

### EXAMPLE 1

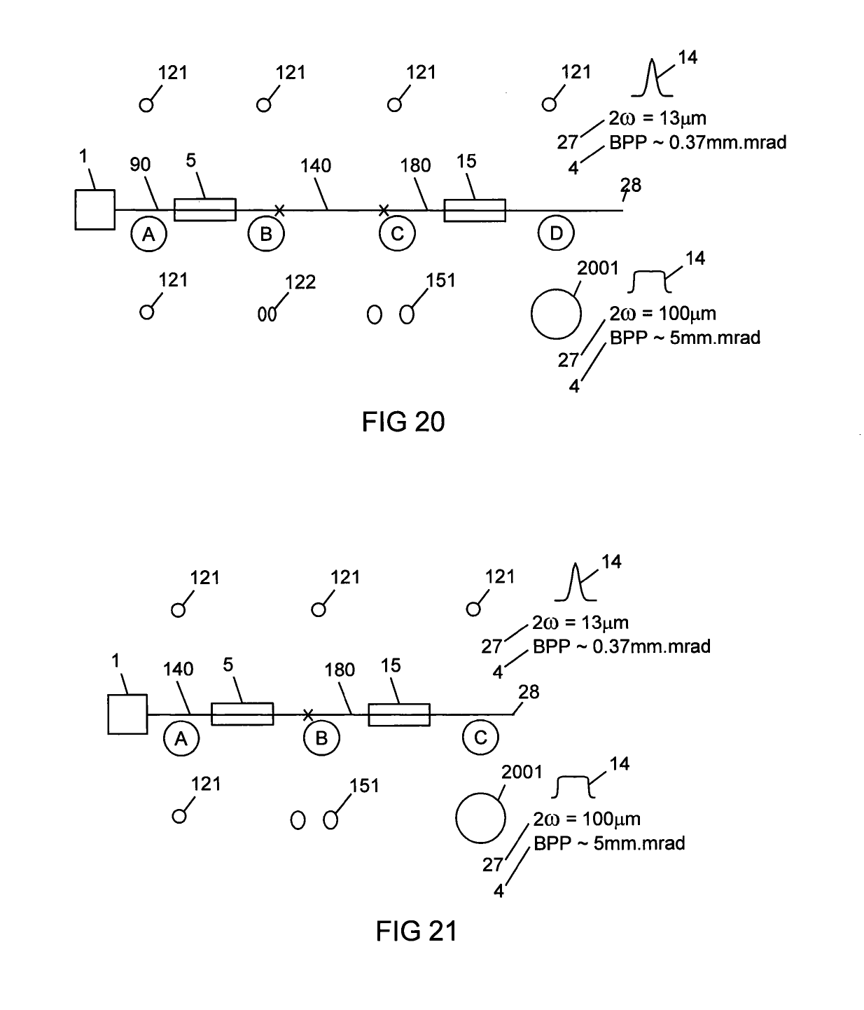

FIG. 20 shows a first Example of the invention. The squeezing mechanism 5 shown in FIG. 1 was applied to the first optical fibre 90 of FIG. 11. The core 91 supported the fundamental mode 121 of FIG. 12 and the second order mode 122 of FIG. 13. The fundamental mode 121 propagated in the core 91 as indicated above and below the first optical fibre 90 at point A. The core 91 had a diameter 92 of order 15 μm and a refractive index 96 which was greater than the cladding index 99 by 0.0034. The squeezing mechanism 5 had a pitch 7 which matched the difference in the effective indices 97 and 98 of the optical modes 121 and 122 such that the pitch 17=2π/Δβ. By adjusting the squeezing force 12 applied by the squeezing mechanism 5, the laser radiation 13 output by the first optical fibre 90 could be switched between the fundamental mode 121 and the second order mode 122 as indicated above and below the first optical fibre 90 at point B of FIG. 20 respectively. It was also possible to switch between combinations of the fundamental mode 121 and the second order mode 122. These combinations are not shown in FIG. 20.

The first optical fibre 90 was spliced to the second optical fibre 140 shown in FIG. 14. The central core 91 of the second optical fibre 140 had the same design as the core 91 of the first optical fibre 90. The four satellite cores 141 had a diameter 143 of 6.6 μm, a refractive index 142 which was the same as the refractive index 96 of the central core 91, and an outer edge to outer edge distance 149 of 36.6 μm. When the squeezing mechanism 5 was adjusted such that the output of the first optical fibre 90 was the fundamental mode 121, the fundamental mode 121 coupled successfully to the core 91 of the second optical fibre 140, and propagated along the second optical fibre 140 without coupling to other higher-order optical modes. The second optical fibre 140 thus emitted the fundamental mode 121 shown above the optical fibre 140 at point C in FIG. 20. When the squeezing mechanism 5 was adjusted such that the output of the first optical fibre 90 was the second order mode 122, the second order mode 122 was transformed to the optical mode(s) 151 shown in FIG. 15 which were output from the satellite cores 141 at the output of the second optical fibre 140. The optical modes 151 are shown below the second optical fibre 140 at point C in FIG. 20. The second optical fibre 140 is thus being used as a transition optical fibre to expand the guided beam diameter 39 of the laser radiation 13 propagating in the fundamental optical mode 121 by a different proportion to an expansion of the guided beam diameter 39 of the laser radiation 13 propagating in the second order optical mode 122.

The output of the second optical fibre 140 was spliced to the third optical fibre 180 of FIG. 18. The third optical fibre 180 is a beam delivery optical fibre. The core 181 of the third optical fibre 180 was the same diameter 92 as the core 91 of the first optical fibre 90. The difference between the core refractive index 183 and the pedestal refractive index 186 was 0.0034. The pedestal 184 had a diameter 185 of 100 um and the difference between the pedestal refractive index 186 and cladding refractive index 99 was 0.014. When the squeezing mechanism 5 was adjusted to select the fundamental mode 121 in the first optical fibre 90, the output of the third optical fibre 180 had an output beam diameter 27 of 13 μm, and a beam quality M² value of approximately 1.1. This corresponds to an output beam profile 14 that is approximately Gaussian, and a beam parameter product 4 of approximately 0.37 mm·mrad. When the squeezing mechanism 5 was adjusted to select the second order mode 122 in the first optical fibre 90, the laser radiation 13 was guided as a laser beam 2001 primarily in the pedestal 184 of the third optical fibre 180 as a combination of many higher order modes (not shown individually). The laser beam 2001 had an output beam diameter 27 of approximately 100 μm, and a beam quality M² factor of approximately 12. This corresponds to an output beam profile 14 that is approximately top hat, and a beam parameter product 4 of approximately 4 mm·mrad.

It was observed that the laser beam 2001 did not have a stable output beam profile 14. Therefore a second squeezing mechanism 15 shown with reference to FIG. 2 was applied to the third optical fibre 180. The pitch 17 of the second squeezing mechanism 15 was longer than the pitch 7 of the squeezing mechanism 5 because it was desired to couple higher order optical modes propagating along the third optical fibre 180 that have closer spaced effective refractive indices (not shown). The use of the second squeezing mechanism 15 ensured a beam quality M² factor of approximately 15 and an even distribution of power within the area of the pedestal 186. The beam parameter product 4 was approximately 5. As shown in FIG. 20, it was then possible to switch the laser radiation 13 being emitted from the optical fibre 180 from an output beam profile 14 having a Gaussian profile with an output beam diameter 27 of 13 μm and beam parameter product 4 of 0.37 mm·mrad to an output beam profile 14 that is approximately top hat and which has an output beam diameter 27 of approximately 100 μm and beam parameter product 4 of 5 mm·mrad by selecting the squeezing force 12 applied to the squeezing mechanism 5. A Gaussian profile is often preferred for piercing a material 11 with a laser beam 13 prior to cutting. The top hat profile is often preferred for cutting a material 11 with the laser beam 3.

### EXAMPLE 2

FIG. 21 shows a second Example of the invention in which the first optical fibre 90 of the First Example has been replaced by the optical fibre 140. The squeezing mechanism 5 shown in FIG. 1 was applied to the fibre 140 shown in FIG. 14. The core 91 had a diameter 92 of approximately 15 um and a refractive index 96 which was greater than the cladding refractive index 99 by 0.0034. The core 91 could support the fundamental mode 121 having the effective refractive index 97. The four satellite cores 141 each had a diameter 143 of 6.6 μm, a refractive index 142 greater than the cladding refractive index 99 by 0.003, and an outer edge to outer distance 149 of 36.6 μm. The satellite cores 141 could propagate mode(s) 151 having an effective refractive index 143. The squeezing mechanism 5 had a pitch 7 designed to match the difference in the effective refractive indices 97 and 143 such that the pitch 7=2π/Δβ. As indicated in FIG. 21, by adjusting the squeezing force 12 applied by the squeezing mechanism 5, the fundamental mode 121 or the optical mode 151 could be selected at the output of the optical fibre 140.

The output of the fibre 140 was spliced to the optical fibre 180 of FIG. 18, whose parameters had the same properties as the third fibre in Example 1. When the squeezing mechanism 5 was adjusted to select the fundamental mode 121 in the fibre 140, the output of the optical fibre 180 was substantially in the fundamental mode 121. When the squeezing mechanism 5 was adjusted to select the optical mode 151 in the optical fibre 140, the laser radiation 13 was guided primarily in the pedestal 184 of the optical fibre 180, and had an output beam diameter 27 of approximately 100 um, and a beam quality M² factor of approximately 12 corresponding to a beam parameter product 4 of approximately 4 mm·mrad. As described in Example 1, the squeezing mechanism 15 shown with reference to FIG. 2 was applied to the optical fibre 180 in order to stabilize the output beam profile 14 at the output 28 of the optical fibre 180. As shown in FIG. 21, it was then possible to switch the laser radiation 13 being emitted from the optical fibre 180 from a Gaussian profile having an output beam diameter 27 of 13 μm and beam parameter product of 0.37 mm·mrad to an approximately top hat profile having an output beam diameter 27 of approximately 100 μm and beam parameter product 4 of 5 mm·mrad by selecting the squeezing force 12 applied to the squeezing mechanism 5.

### EXAMPLE 3

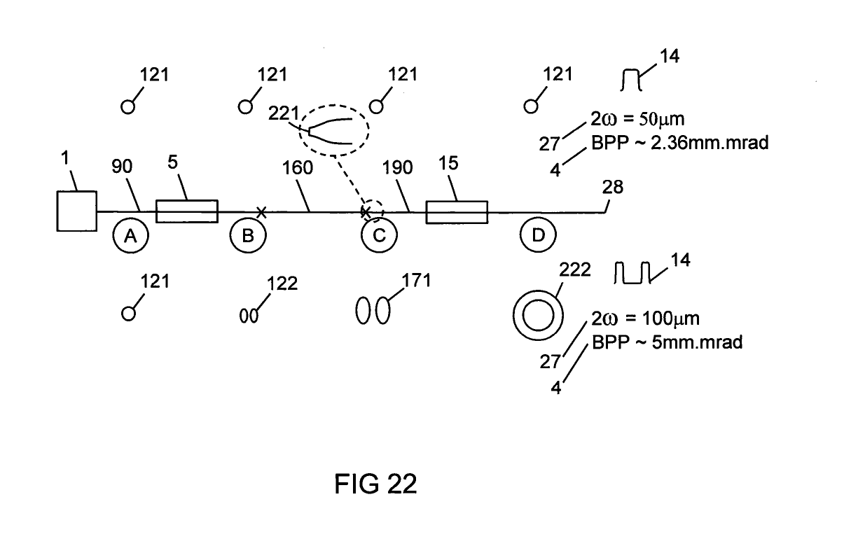

FIG. 22 shows a third Example of the invention in which the second optical fibre 140 of the first Example has been replaced by the second optical fibre 160 of FIG. 16, and the third optical fibre 180 of the first Example has been replaced by the third optical fibre 190 described with reference to FIG. 19. The design of the first optical fibre 90 was the same as described with reference to the first Example and FIG. 20.

The first optical fibre 90 was spliced to the second optical fibre 160 shown in FIG. 16. The central core 91 of the second optical fibre 160 was the same design as the core 91 of the first optical fibre 90. The ring core 161 had an outer diameter 169 of 40 μm, a thickness 164 of 5 μm, and a refractive index 162 that was greater than the cladding refractive index 99 by 0.0026. When the squeezing mechanism 5 was adjusted such that the output of the first optical fibre 90 was the fundamental mode 121, the fundamental mode 121 coupled successfully to the core 91 of the second optical fibre 160, and propagated along the second optical fibre 160 without coupling to other higher-order optical modes. When the squeezing mechanism 5 was adjusted such that the output of the first optical fibre 90 was the second order mode 122, the second order mode 122 was transformed to the optical mode(s) 171 shown in FIG. 17 which was output from the ring core 161 at the output of the second optical fibre 160.

The core 191 of the third optical fibre 190 of FIG. 19 had a diameter 192 of 50 μm. The core refractive index 193 was greater than the pedestal refractive index 99 by 0.014. The ring core 194 had an outer diameter 195 of 100 μm, a thickness 199 of 20 μm and a refractive index 196 that was greater than the cladding index 99 by 0.014. The core diameter 192 was larger by approximately 2.5 times the core diameter 92 of the second optical fibre 160. It was therefore necessary to taper the third optical fibre by a taper ratio of approximately 2.5 such that the corresponding transverse dimensions of the second and the third optical fibres 160 and 190 matched at the input 221 of the third optical fibre 190.

When the squeezing mechanism 5 was adjusted to select the fundamental mode 121 in the first fibre 90, the output of the third fibre 180 had an output beam diameter 27 of 50 μm and a beam quality M² value of approximately 4, which corresponds to a beam parameter product of approximately 1.35 mm·mrad. When the squeezing mechanism 5 was adjusted to select the second order mode 122 in the first optical fibre 90, the laser radiation 13 was guided in the outer core 194 of the third optical fibre 190, and had an output beam diameter 27 of approximately 100 um, and a beam quality M² factor of approximately 12, corresponding to a beam parameter product 4 of approximately 4 mm·mrad.

A second squeezing mechanism 15 shown with reference to FIG. 2 was applied to the third optical fibre 190. The pitch 17 of the second squeezing mechanism 15 was longer than the pitch 7 of the squeezing mechanism 5 because it was desired to couple higher order optical modes propagating along the optical fibre 190 that have closer spaced effective refractive indices (not shown). The second squeezing mechanism 15 was adjusted by adjusting the squeezing force 12. When the fundamental mode 121 was selected at the output of the first optical fibre 90 by applying a squeezing force 12 to the squeezing mechanism 5, the laser beam 13 at the output of the third optical fibre 190 had a beam quality M² factor of approximately 7 which corresponds to a beam parameter product 14 of approximately 2.36 mm·mrad. The laser radiation 13 was approximately evenly distributed in the core 191. When the second order mode 122 was selected at the output of the first optical fibre 90, the beam quality M² factor at the output 28 of the third optical fibre 190 was approximately 15, corresponding to a beam parameter product 4 of approximately 5 mm·mrad. The optical power was approximately evenly distributed within the ring core 194. When a combination of the fundamental mode 121 and the second order mode 122 was selected in the first fibre 90 by adjusting the squeezing force 12 applied to the squeezing mechanism 5, any relative distribution between approximately 0% and approximately 100% of total power between the core 191 and the ring core 194 could be achieved. As shown in FIG. 22, it was then possible to switch the laser radiation 13 being emitted from the optical fibre 190 from an approximately top hat profile 14 having an output beam diameter 27 of 50 μm and beam parameter product of 2.36 mm·mrad to an approximately top hat ring profile 14 having an output beam diameter 27 of approximately 100 μm and beam parameter product 4 of 5 mm·mrad by selecting the squeezing force 12 applied to the squeezing mechanism 5. An output beam profile 14 having a top hat ring profile is often preferred over an output beam profile 14 having a top hat profile or a bell-shaped Gaussian beam profile for cutting a material 11 with a laser beam 13. It should be noted that if it were desired to switch from a bell-shaped Gaussian profile (M² ˜1.1) to the top hat ring profile, then the taper 225 can be designed such that it is adiabatic such that the fundamental mode 121 propagates along the optical fibres 90, 160, the taper 255, and the optical fibre 190 without mode coupling.

Examples 1 and 2 both used the optical fibre 180 and the second mechanism 15. However these may be omitted if it is desired to switch the laser radiation 13 emitted from the apparatus 10 from the fundamental mode 121 and the modes 151 of the satellite cores 141. This can be advantageous for certain welding applications in which multiple closely spaced beams are desired.

The squeezing mechanism 5 and the squeezing mechanism 15 used in Examples 1-3 were of the linear variety described with reference to FIGS. 1 and 2. Either or both of the squeezing mechanism 5 and the squeezing mechanism 15 could be replaced by the squeezing mechanisms described with reference to FIGS. 3 to 10. Preferably, the squeezing mechanism 5 and the squeezing mechanism 15 would be the helical squeezing mechanisms described with reference to FIGS. 3 to 7. Such squeezing mechanisms enable lower squeezing forces 12 to be applied for the same amount of mode conversion, and hence improve reliability. Such squeezing mechanisms also couple optical modes of all orientations, and thus reduce the formation of hot spots that are sometimes seen in the output beam profile 14. When coupling between two defined optical modes, such as the fundamental mode 121 and the second order mode 122, a uniform pitch 7 or 17 is preferred. When coupling between various optical modes, such as when the second squeezing mechanism 15 was applied to the optical fibres 180 and 190 in Examples 1 to 3, a chirped pitch 7 or 17 is preferred. It is preferred that the pitch 7 or 17 when coupling between various higher order optical modes is longer than when coupling between the fundamental mode 121 and the second order mode 122.

The use of more than one squeezing mechanism 5 simplifies the automatic control of the parameters of the laser radiation 13. Beam divergence 22, diameter 21, and mode profile 14 can be controlled. Additionally, the use of different squeezing mechanisms 5 on optical fibres 9 having different guidance properties improves the range of control that can be applied. For example, the optical fibre 9 and the optical fibre 19 can each be the optical fibre 90 of FIG. 11. The diameter 93 of the optical fibre 90 can be 75 μm enabling the pitch 7 to be as small as 0.5 mm. The diameter 93 of the optical fibre 19 may be 250 μm, the core 91 can be more multimoded than the core 91 of the optical fibre 9. The pitch 17 is then preferably longer than the pitch 7, for example in the range 2 mm to 8 mm. In addition, at least one of the squeezing mechanisms 5 and 15 can be of the form shown in FIG. 3, with the optical fibre 9 or 19 being able to be deformed into a helix, which may have a pitch 7 or 17 that is uniform or chirped. It should be noted that one of these mechanisms 5 can be replaced by another mode coupling device such as for example a splice having an offset core.

As shown with reference to FIG. 1, the apparatus 10 may include a vibrating element 36 attached to, or forming part of, the beam delivery cable 2. The vibrating element 36 can be configured to vibrate the beam delivery cable 2. This can be advantageous to remove laser speckle from the laser radiation 13, or to remove hot spots from the output beam profile 14 of the laser radiation 13. The vibrating element 36 can be a piezo electric element or an electro-magnetic element.

The optical fibre 9 and the optical fibre 19 shown in FIG. 1 can be any of the optical fibres 90, 140, 160, 180, and 190 described with reference to FIGS. 11, 14, 16, 18 and 19. The optical fibre 9 and the optical fibre 19 may have solid cores and claddings, can have additional cores and claddings, including depressed claddings, and can have longitudinally extending holes within the core and/or cladding. The discussion has mainly focused on the coupling of the LP₀₁ fundamental mode to the LP₁₁ second order mode. However the squeezing mechanisms 5, 15, 40, 50, 60, and 82 can be used to cause mode coupling between other sets of optical modes.

It is to be appreciated that the embodiments of the invention described above with reference to the accompanying drawings have been given by way of example only and that modifications and additional components may be provided to enhance performance. Individual components shown in the drawings are not limited to use in their drawings and they may be used in other drawings and in all aspects of the invention. The invention also extends to the individual components mentioned and/or shown above, taken singly or in any combination.

1. Apparatus for laser processing a material, which apparatus comprises a laser and an optical fibre, wherein:
the laser is connected to the optical fibre;
the optical fibre is configured to transmit laser radiation emitted from the laser; and
the laser radiation is defined by a beam parameter product;
and the apparatus is characterized in that:
the apparatus includes at least one squeezing mechanism comprising a periodic surface defined by a pitch;
the optical fibre is located adjacent to the periodic surface; and
the squeezing mechanism is configured to squeeze the periodic surface and the optical fibre together with a squeezing force;
whereby the beam parameter product is able to be varied by adjusting the squeezing force.

2. Apparatus according to claim 1 wherein the periodic surface is chirped.

3. Apparatus according to claim 1 wherein the squeezing mechanism comprises at least two of the periodic surfaces arranged at an angle to each other and wherein spatial phases of the periodic surfaces are configured such that the optical fibre is deformed in a helical manner when the squeezing forces are applied to the periodic surfaces.

4.-27. (canceled)

28. Apparatus according to claim 1, wherein the optical fibre comprises a core that supports a first optical mode having a propagation constant β₁ and at least one satellite core that supports a second optical mode having a propagation constant β₂, and the pitch is selected to couple the first optical mode to the second optical mode, thereby enabling optical power to be transferred between the core and the satellite core using the squeezing mechanism.

29.-30. (canceled)

31. Apparatus according to claim 28 wherein the satellite core is a ring core.

32.-33. (canceled)

34. Apparatus according to claim 28 and including a transition optical fibre comprising a central core and at least one satellite core, which satellite core is configured to expand the beam diameter of the laser radiation propagating in the first optical mode by a different proportion to an expansion of the beam diameter of the laser radiation propagating in the second optical mode.

35.-36. (canceled)

37. Apparatus according to claim 28 and including a beam delivery optical fibre comprising a central core, which beam delivery optical fibre comprises an output end from which the laser radiation is emitted.

38. (canceled)

39. Apparatus according to claim 37 wherein the beam delivery optical fibre includes a ring core surrounding the central core.

40. Apparatus according to claim 37 and including a taper wherein the taper is such that a diameter of the central core increases towards the output end.

41. Apparatus according to claim 37 wherein there are two of the squeezing mechanisms, the second squeezing mechanism has a periodic surface defined by a pitch, and wherein the periodic surface of the second squeezing mechanism is applied to the beam delivery optical fibre.

42. Apparatus according to claim 41 wherein the pitch of the second squeezing mechanism is greater than the pitch of the first squeezing mechanism and the pitch of the second squeezing mechanism is selected to couple higher order modes that can propagate in the beam delivery optical fibre together, thereby creating a more uniform output beam profile.

43.-44. (canceled)

45. Apparatus according to claim 37 and including a lens system positioned to receive the laser radiation from the beam delivery optical fibre and wherein the lens system is such that a diameter of a focused spot on the material is able to be varied.

46.-50. (canceled)

51. Apparatus according to claim 45 wherein the apparatus comprises a first optical fibre and a second optical fibre, the first optical fibre has a first core diameter, and the second optical fibre has a second core diameter which is larger than the first diameter, the second optical fibre is located between the processing head and the first optical fibre, a first one of the squeezing mechanisms is applied to the first optical fibre, and a second one of the squeezing mechanisms is applied to the second optical fibre, whereby in use a spot size of the laser radiation propagating in the first optical fibre is varied with the first squeezing mechanism, and a profile of the laser radiation is varied with the second squeezing mechanism.

52. Apparatus according to claim 37 and including a vibrating element attached to the beam delivery optical fibre, thereby enabling laser speckle to be removed from the laser radiation.

53. A method for laser processing a material, which method comprises providing a laser and an optical fibre, wherein
the optical fibre is configured to transmit laser radiation from the laser, and
the laser radiation is defined by a beam parameter product;
the apparatus includes at least one squeezing mechanism comprising a periodic surface defined by a pitch;
the optical fibre is located adjacent to the periodic surface; and
the squeezing mechanism is configured to squeeze the periodic surface and the optical fibre together with a squeezing force;
and adjusting the squeezing force in order to vary the beam parameter product.

54.-58. (canceled)

59. Apparatus according to claim 1 and including a beam delivery optical fibre, wherein:
the periodic surface is chirped;
the optical fibre comprises a core that supports a first optical mode having a propagation constant β₁ and at least one satellite core that supports a second optical mode having a propagation constant β₂, and the pitch is selected to couple the first optical mode to the second optical mode;
the satellite core is a ring core, comprising a central core; and
the beam delivery optical fibre comprises a ring core surrounding the central core.

60. Apparatus according to claim 59 and including a transition optical fibre comprising a central core and at least one satellite core, which satellite core is configured to expand the beam diameter of the laser radiation propagating in the first optical mode by a different proportion to an expansion of the beam diameter of the laser radiation propagating in the second optical mode.

61. Apparatus according to claim 60 wherein:
there are two of the squeezing mechanisms;
the second squeezing mechanism has a periodic surface defined by a pitch;
the periodic surface of the second squeezing mechanism is applied to the beam delivery optical fibre;
the pitch of the second squeezing mechanism is greater than the pitch of the first squeezing mechanism; and
the pitch of the second squeezing mechanism is selected to couple higher order modes that can propagate in the beam delivery optical fibre together, thereby creating a more uniform output beam profile.

62. Apparatus according to claim 61 and including a lens system positioned to receive the laser radiation from the beam delivery optical fibre, and wherein the lens system is such that a diameter of a focused spot on the material is able to be varied.
